(19) United States
(12) Patent Application Publication
(10) Pub. No.: US 2021/0199581 A1
(43) Pub. Date: Jul. 1, 2021

(54) PHOTOCATALYTIC LAYER ON PLASMONICALLY ACTIVE SURFACE

(71) Applicant: HEWLETT-PACKARD DEVELOPMENT COMPANY, L.P., Houston, TX (US)

(72) Inventors: Christopher N. YOUNG, Corvallis, OR (US); Milo OVERBAY, Corvallis, OR (US)

(73) Assignee: HEWLETT-PACKARD DEVELOPMENT COMPANY, L.P., Houston, TX (US)

(21) Appl. No.: 16/077,378

(22) PCT Filed: Jul. 20, 2017
(86) PCT No.: PCT/US2017/042949

§ 371 Date: Aug. 10, 2018

(51) Int. Cl. G01N 21/64; G01N 21/65; G02B 1/12

(52) U.S. Cl. CPC G01N 21/648; G02B 1/12; G01N 21/658

(57) ABSTRACT

A plasmonic analyte interrogation stage may include a plasmonically active surface and a transition metal photocatalytic layer on the plasmonically active surface.

### BACKGROUND

Plasmonic analyte interrogation stages are sometimes used for sensing and analyzing the structure of an analyte, such as inorganic materials and complex organic molecules. Plasmonic sensing may interrogate an analyte on or near a plasmonic surface by focusing electromagnetic radiation or light onto the plasmonic surface and onto the analyte and then sensing an optical response of the analyte.

### BRIEF DESCRIPTION OF THE DRAWINGS

FIG. 1 is a side view schematically illustrating an example plasmonic analyte interrogation stage.

FIG. 2 is a flow diagram of an example method for interrogating an analyte.

FIG. 3 is a side view schematically illustrating an example plasmonic analyte interrogation stage.

FIG. 4 is a flow diagram of an example method for interrogating an analyte.

FIG. 5 is a sectional view of an example plasmonic analyte interrogation stage.

FIG. 6 is a top view of the example stage of FIG. 5.

FIG. 7 is a sectional view of another example plasmonic analyte interrogation stage.

FIG. 8 is a sectional view of another example plasmonic analyte interrogation stage.

FIG. 9 is a sectional view of another example plasmonic analyte interrogation stage.

FIG. 10 is a top view of the example stage of FIG. 9.

FIG. 11 is a side view of an example plasmonic analyte interrogation stage.

FIG. 12 is a top view of the example plasmonic stage of FIG. 11.

FIG. 13 is a side view of an example plasmonic analyte interrogation stage undergoing irradiation to clean contaminants from a plasmonically active surface.

FIG. 14 is a side view of the example stage of FIG. 13, illustrating separation of an adhesive layer and photocatalytic layer.

FIG. 15 is a side view of the example stage of FIG. 14, illustrating application of an analyte.

FIG. 16 is a side view of the example stage of FIG. 15, illustrating closing of pillars of the stage.

FIG. 17 is a side view of the example stage of FIG. 16 undergoing interrogation by an SEL sensor.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

In many analyte interrogation applications, the analyte being interrogated and analyzed is adsorbed onto or adjacent a plasmonically active surface. Prior to be exposed to the analyte to be tested, the plasmonically active surface may become contaminated. Such contamination may detrimental in the reliability or accuracy of the interrogation and analysis of the analyte. Examples of plasmonic analyte interrogation applications comprise Raman spectroscopy, surface enhanced Raman spectroscopy (SERS), luminescence; surface enhanced luminescence (SEL), surface enhanced fluorescence and others.

Disclosed herein are example plasmonic analyte interrogation stages for use in plasmonic analyte interrogation applications. The disclosed example plasmonic sensing stages facilitate cleaning of the plasmonically active surfaces prior to their exposure to the analyte to be tested. The example plasmonic sensing stages may include a thin layer of a transition metal photocatalytic material adjacent to or on the plasmonically active surface. Prior to exposing the plasmonically active surface to the analyte to be tested, the transition metal photocatalytic material is irradiated such that the photocatalytic material removes any contaminants that may reside on the plasmonically active material.

In some implementations, the layer of transition metal photocatalytic material is imperforate and covers the plasmonically active material, but is sufficiently thin given the level and duration of irradiation such that the plasmonically active material may be cleaned and may interact with the subsequently applied analyte. In other implementations, the layer of transition metal photocatalytic material is perforate, facilitating direct subsequent exposure of the underlying plasmonically active material to the analyte. In yet other implementations, the layer of transition metal photocatalytic material is adhered to the underlying plasmonically active material by an adhesive, either in a continuous layer or as spaced deposits, on the plasmonically active layer. In such an implementation, the adhesive is chosen such that during the irradiation, the adhesive degrades to a sufficient extent such that the layer of transition metal photocatalytic material, after “cleaning” the plasmonically active layer, falls off of the plasmonically active material, along with the layer of transition metal photocatalytic material or is otherwise removable with the layer of transition metal photocatalytic material through washing or other processes.

In some implementations, an analyte adsorbing layer, such as a gold layer, may be formed on top of the plasmonically active layer, sandwiching the plasmonically active layer between the analyte adsorbing layer and the layer of the transition metal for catalytic material. In such an implementation, the analyte adsorbing layer may be perforate, facilitating irradiation of the underlying layer of transition metal photocatalytic material. The analyte adsorbing layer may enhance adsorption of the subsequently applied analyte.

Disclosed herein is an example of a plasmonic analyte interrogation stage that may include a plasmonically active surface and a transition metal photocatalytic layer on the plasmonically active surface.

Disclosed herein is an example method for interrogating an analyte. The method may comprise irradiating a transition metal photocatalytic layer upon an analyte free plasmonically active surface to clean contaminants from the analyte free plasmonically active surface, binding an analyte on or approximate to the cleaned plasmonically active surface and irradiating the analyte and the plasmonically active surface to interrogate the analyte.

Disclosed herein is an example surface enhanced luminescence (SEL) plasmonic analyte interrogation stage that may comprise a substrate and pillars rising from the substrate. Each pillar may comprise a rod or post formed from a non-photocatalytic material and a plasmonically active cap supported by the rod. A transition metal photocatalytic layer extends proximate the plasmonically active cap.

FIG. 1 is a schematic diagram of portions of an example plasmonic analyte interrogation stage 20. Stage 20 facilitates cleaning of a plasmonically active surface prior to its exposure to the analyte to be tested. Stage 20 comprises plasmonically active material layer 40 and transition metal photocatalytic layer 46. Layer 40 is formed from a plasmonically active material and provides a plasmonically active surface 42. In one implementation, layer 40 comprises a layer of gold. In other implementations, layer 40 may comprise other plasmonically active material such as a transition metal. In some implementations, layer 40 may comprise a plasmon at the active material such as silver, copper, aluminum or other suitable conductive materials with complex dielectric properties chosen to maximize resonance at the interrogation wavelength of choice. In one implementation, layer 40 is formed upon a substrate formed from a material such as silicon, ceramics, glass and the like. In some implementations, layer 40 is formed upon a regularly patterned or irregularly patterned surface facilitating surface enhanced luminescence or surface enhanced Raman spectroscopy. For example, in one implementation, layer 40 may be formed upon a roughened surface or upon tips of pillars or nano wires. Surface 40 is to exhibit plasmonic resonance upon being irradiated.

Photocatalytic layer 46 at least partially overlies plasmonically active layer 40. Photocatalytic layer 46 is chosen so as to clean contaminants from surface 42 upon being irradiated. In one implementation, layer 46 is formed from a transition metal photocatalytic material such as TiO₂, whereupon being irradiated for a sufficient period of time, such as with ultraviolet radiation, the TiO₂ material decomposes water or oxygen at the surface by photocatalytic oxidation, producing free radicals that clean and remove contaminants upon the plasmonically active layer 40. In one implementation, the photocatalytic layer 46 is formed from material such as TiO₂ and has a thickness of no greater than 10 nm. In yet other implementations, the photocatalytic layer 46 is formed from material such as TiO₂ and has a thickness of no greater than 2 nm. The reduced thickness may facilitate greater proximity of the subsequent analyte to the plasmonically active surface 42, resulting in a greater response upon being interrogated. The reduced thickness of layer 46 may further shorten the time and power of irradiation for decomposing layer 46 and cleaning layer 40.

In one implementation, photocatalytic layer 46 is deposited or formed upon plasmonically active surface 42 by atomic layer deposition. In one implementation, the layer 46 deposited by atomic layer deposition comprises a monolayer, a layer having a thickness of one molecule. In other implementations, layer 46 deposited by atomic layer deposition may have a greater thickness. In yet other implementations, layer 46 may be deposited through other methods such as chemical vapor deposition, thermal or e-beam evaporation, or plasma-enhanced variants of the preceding techniques.

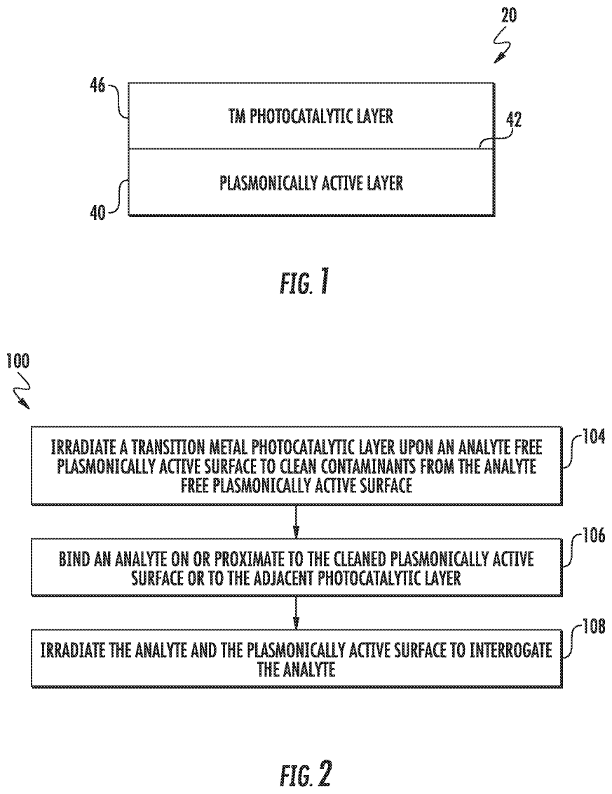

FIG. 2 is a flow diagram of an example method 100 for interrogating an analyte. Although method 100 is described as being carried out with stage 20 described above, it should be appreciated that method 100 may be carried out with any of the analyte interrogation stages described hereafter or using similar analyte interrogation stages. As indicated by block 104, a transition metal photocatalytic layer 46, deposited upon an analyte free plasmonically active surface 42, is irradiated with light, such as ultraviolet light, so as to clean contaminants from the analyte free plasmonically active surface 42. In one example, the irradiation causes the transmission metal photocatalytic layer 46 to undergo photocatalytic oxidation, producing free radicals that degrade, clean and remove contaminants from the underlying or adjacent surface 42.

As indicated by block 106, an analyte to be tested, such as inorganic materials or complex organic molecules, is bound on or proximate to the cleaned plasmonically active surface. In one implementation, the analyte is bound to a surface sufficiently close to the cleaned plasmonically active surface such that molecules of the analyte are near or within an electric field formed by the excited and oscillating free electrons of the plasmonically active surface produced in block 108.

As indicated in block 108, the analyte and the plasmonically active surface are irradiated with electromagnetic radiation or light, such as ultraviolet, visible, or near-infrared light, to interrogate the analyte. In one implementation, the electromagnetic radiation or light excites free electrons in the plasmonically active surface such that the free electrons form an oscillating electric field. The oscillating electric field enhances an optical response of the analyte to the interrogating light. The optical response such as luminescence response or spectroscopic response, is sensed to identify characteristics of the analyte.

FIG. 3 is a schematic diagram illustrating portions of another example plasmonic analyte interrogation stage 220. Stage 220 is similar to stage 20 described above except that stage 220 additionally comprises adhesive layer 248 sandwiched between plasmonically active surface 42 and photocatalytic layer 46. Adhesive layer 248 concurrently joins layers 40 and 46. Adhesive layer 248 is chosen so as to separate or be separable from surface 42 in response to the light used to irradiate layer 46 producing the free radicals that clean surface 42. In one implementation, adhesive layer 248 degrades or decomposes during the irradiation of layer 246 to cause layer 246 to undergo photocatalytic oxidation, wherein layer 46 and whatever remains of layer 248 separate and fall from surface 42 of layer 40. In some implementations, following the cleaning of surface 42 through the photocatalytic oxidation of layer 46, surface 42 undergoes a washing to separate and remove remaining components or elements of the photocatalytic layer 46 and adhesive layer 248. Removal of layer 46 and layer 248 may provide a larger surface area of surface 42 upon which an analyte may be subsequently absorbed.

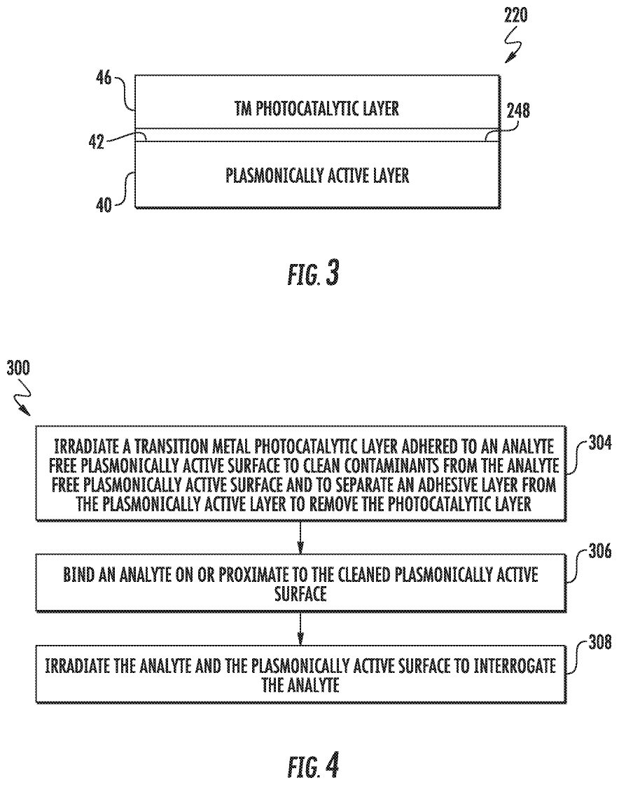

FIG. 4 is a flow diagram of an example method 300 for interrogating an analyte. Although method 300 is described as being carried out using plasmonic sensing stage 220, it should be appreciated that method 300 may be carried out using other similar plasmonic sensing stages. As indicated by block 304, a transition metal photocatalytic layer 46, deposited upon an analyte free plasmonically active surface 42, is irradiated with light, such as ultraviolet light, so as to clean contaminants from the analyte free plasmonically active surface 42. In one example, the irradiation causes the transmission metal photocatalytic layer 46 to oxidize nearby molecules, converting water adsorbed on its surface to radicals which then react with nearby molecules causing degradation and evaporation of the contaminants on the underlying or adjacent surface 42.

In addition to causing layer 46 to undergo photocatalytic oxidation and clean surface 42, the light irradiating layer 46 causes an adhesive layer to separate from the plasmonically active layer 40. In one implementation, adhesive properties of the adhesive layer with respect to the plasmonically active layer lessen. In one implementation, the adhesive layer degrades or decomposes. As a result, the adhesive layer, or its remnants, along with the photocatalytic layer 46, or its remnants, fall away from, or become more easily separated from, surface 42 of the plasmonically active layer 40. In one implementation, the photocatalytic layer 46 and the adhesive layer 248 are removed through a washing process.

As indicated by block 306, an analyte to be tested, such as inorganic materials or complex organic molecules, is bound on or proximate to the cleaned plasmonically active surface. In one implementation, the analyte is bound to a surface sufficiently close to the cleaned plasmonically active surface such that molecules of the analyte are near or within an electric field formed by the excited and oscillating free electrons of the plasmonically active surface produced in block 308.

As indicated in block 308, the analyte and the plasmonically active surface are irradiated with electromagnetic radiation or light, such as ultraviolet, visible, or near-infrared light, to interrogate the analyte. In one implementation, the electromagnetic radiation or light excites free electrons in the plasmonically active surface such that the free electrons form and oscillating electric field. The oscillating electric field enhances an optical response of the analyte to the interrogating light. The optical response such as luminescence response or spectroscopic response, is sensed to identify characteristics of the analyte.

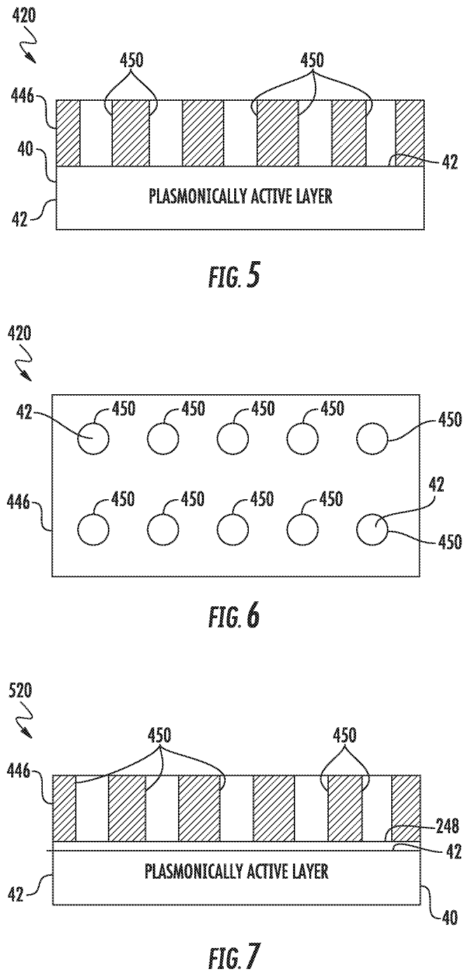

FIGS. 5 and 6 schematically illustrate portions of another example plasmonic analyte interrogation stage 420. Stage 420 is similar to stage 20 described above except that stage 420 comprises an incomplete transition metal photocatalytic layer 446 over at least portions of surface 42 of plasmonically active layer 40. Layer 446 may have a thickness similar to that described above with respect to layer 46. Layer 446 is “incomplete” in that layer 446 does not continuously coat or cover, without interruption, all of surface 42 opposing layer 446. As a result, a greater portion of surface 42 or a greater area of surface 42 may be exposed to the substantively applied analyte, potentially enhancing adsorption of the analyte to surface 42.

In the example illustrated, layer 446 is perforate, comprising perforations 450 which extend completely through layer 446 to the underlying surface 42 of plasmonically active layer 42. As shown by FIG. 6, in the example illustrated, perforations 450 are uniformly sized and uniformly spaced in an array across surface 42. In other implementations, perforations 450 may be irregularly spaced or formed in other patterns or irregularly positioned across surface 42. In one implementation, perforations 450 expose at least 25% of the underlying plasmonically active surface 42 that extends opposite to layer 446. In another implementation, perforations 450 expose at least 50% and nominally 60 to 95% of the underlying plasmon as the active surface that extends opposite to layer 446. In other implementations, perforations 450 may expose other percentages of surface 42. Although perforations 450 are illustrated as being cylindrical, in other implementations, perforations for 50 may have other sizes and shapes. In some implementations, perforations 450 may be in the form of channels or grooves extending part way across or completely across surface 42. In some implementations, layer 446 may be incomplete through use of a combination of apertures and grooves. In some implementations, layer 446 may be incomplete in that perimeter portions of surface 42, facing in the same direction as those portions of surface 42 that extend opposite to layer 446, are not covered by layer 446.

FIG. 7 schematically illustrates portions of another example plasmonic sensing stage 520. Stage 520 is similar to stage 220 described above except that stage 420 comprises an incomplete transition metal photocatalytic layer 446 extending over at least portions of surface 42 of plasmonically active layer 40. Layer 446 may have a thickness similar to that described above with respect to layer 46. Layer 446 is “incomplete” or “sparse” in that layer 446 does not continuously coat or cover, without interruption, all of surface 42 opposing layer 446. As a result, adhesive layer 248 may be more directly exposed to the light irradiating layer 446 during the cleaning of surface 42, potentially enhancing the ability of layer 248 and layer 4462 separate from plasmonically active layer 42.

FIG. 8 schematically illustrates portions of another example plasmonic analyte interrogation stage 620. Stage 620 is similar to stage 20 described above except that stage 620 additionally comprises analyte adsorption layer 660 overlying transition metal photocatalytic layer 46 with photocatalytic layer 46 being sandwiched between layer 660 and plasmonically active layer 40. Layer 660 comprises a layer having properties that facilitate adherence or adsorption of an analyte of interest to layer 660. Layer 660 is sufficiently thin such that any analyte adsorbed upon layer 660 is within sufficient proximity to surface 42 of plasmonically active layer 40 so as to exhibit enhanced optical response characteristics due to the analyte being within or near the oscillating electric field during irradiation of the plasmonically active surface to interrogate the analyte. In one implementation, layer 660 has a thickness of no greater than 10 nm. In one implementation, layer 60 has a thickness of no greater than 2 nm. The reduced thickness of layer 660 facilitates a closer spacing between the adsorbed analyte and the plasmonically active layer 40 for enhanced optical response of the analyte when being interrogated by a laser or other light.

As shown by FIG. 8, layer 660 additionally comprises perforations 662. Perforations 662 extend completely through layer 660 to photocatalytic layer 46. As a result, perforations 662 facilitate direct impingement of layer 446 with light such that layer 46 undergoes enhanced photocatalytic oxidation. In one implementation, layer 660 may be formed from a metal, such as gold or silver, wherein layer 46, upon being irradiated, produces free radicals that additionally clean contaminants from the surface 664 of layer 660.

In one implementation, perforations 662 comprise cylindrical bores or apertures. In other implementations, perforations 662 may have other shapes. For example, in other implementations, perforations 662 may comprise oval or polygonal bores. In some implementations, perforations 62 may comprise channels or grooves.

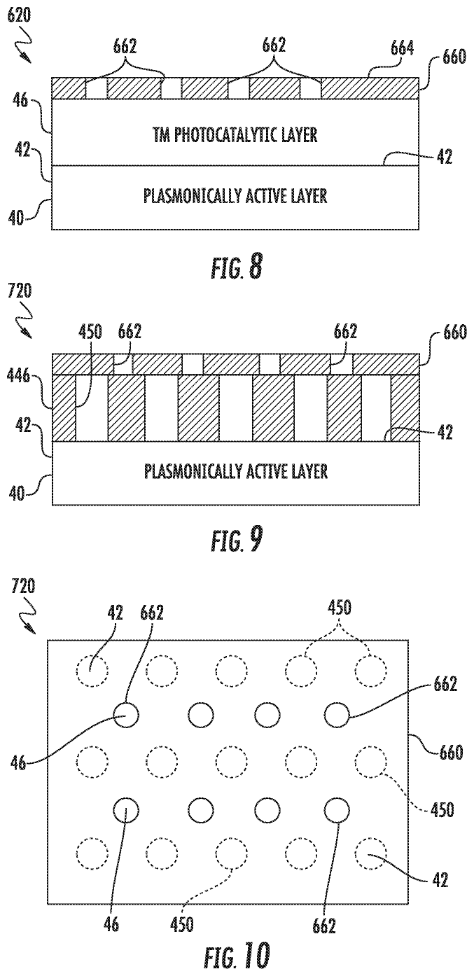

FIGS. 9 and 10 schematically illustrates portions of another example plasmonic analyte interrogation stage 720. Stage 720 is similar to stage 620 except that stage 720 comprises transition metal photocatalytic layer 446 in place of transition metal photocatalytic layer 46. Those remaining components of stage 720 which correspond to components of stage 620 are numbered similarly.

The perforations 662 facilitate direct impingement of layer 446 with light such that layer 446 causes photocatalytic oxidation. In one implementation, layer 660 may be formed from a metal, such as gold or silver, wherein layer 46, upon being irradiated, produces free radicals that additionally clean contaminants from the surface 664 of layer 660. Although perforations 662 are illustrated as being offset or staggered with respect to perforations 450 to facilitate direct impingement of layer 446 with light during the irradiation of layer 446 and the cleaning of surfaces 42 and surfaces 664, in other implementations, perforations 662 may be aligned with perforations 450 such that analyte may directly absorb on surface 42, in addition to surface 664.

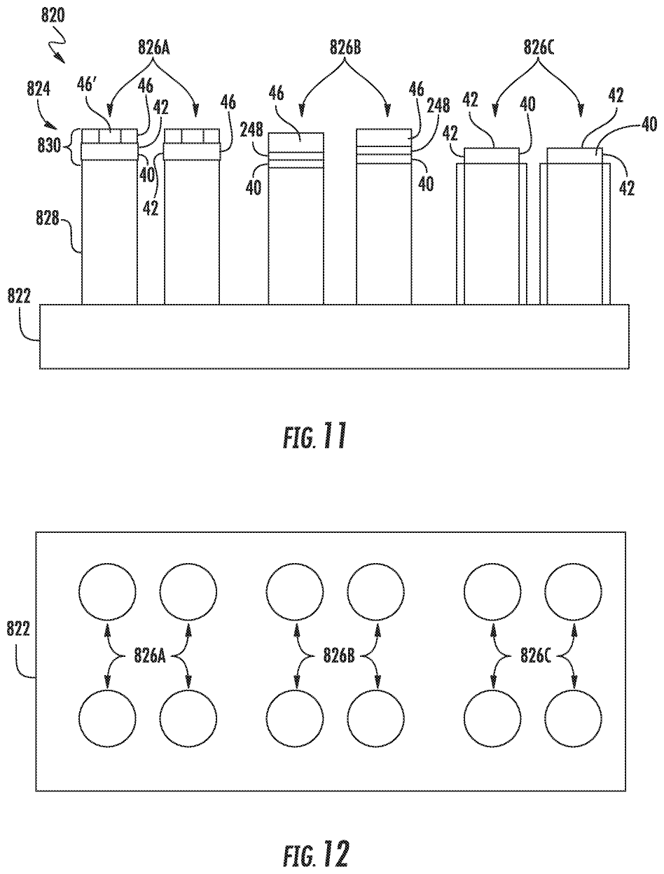

FIGS. 11 and 12 schematically illustrate portions of another example plasmonic analyte interrogation stage 820. Analyte interrogation stage 820 comprise a regularly patterned non-flat surface that facilitates surface enhanced luminescence (SEL) interrogation processes such as surface enhanced fluorescence and surface enhanced Raman spectroscopy processes. Stage 820 comprises substrate 822 and a set or array 824 of pillars 826A, 826B and 826C (collectively referred to as pillars 826) projecting arising from substrate 822. For the purpose of illustration, FIGS. 11 and 12 illustrate various different types of pillars 826A, 826B and 826C extending from a single substrate 822. It should be appreciated that array 824 may comprise a single type of pillar, wherein each of the pillars of an array 824 are the same type.

Each of pillars 826 (sometimes referred to as nano fingers or nano wires) comprises a post 828 and a head portion 830. Post 828 supports head portion 830. Each post 828 is dimensioned so as to be bendable such that had portions 826 of two adjacent pillars 826 may be brought into close, near contact with one another. In one implementation, each post 828 is formed from material and is dimensioned so as to be bendable in response to capillary forces to position had portions 828 of two consecutive pillars 826 within 3 nm of one another. In one implementation, each post 828 is formed from material and is dimensioned so as to be bendable in response to capillary forces to position had portions 828 of two consecutive pillars 826 within 1 nm of one another.

In one implementation, such posts 828 have an aspect ratio of and at least 10:1 (a height of at least 10 times the thickness or diameter). In one implementation, such posts have a thickness or diameter between 50 nm and 100 nm, while, at the same time, having a height of at least 500 nm and, in one implementation, at least 700 nm. In some implementations, the posts 828 are movable and are self-actuating, wherein such columnar structures bend or flex towards one another in response to micro-capillary forces so as to self-organize, wherein such bending facilitates close spacing between the structures for greater scattered radiation intensity.

In one implementation, each post 828 comprises an elongate column formed from a polymer material. The polymer material facilitates the use of molding, imprinting or other fabrication techniques to form post 828. The polymer material further facilitates bending and flexing of post 828 and subsequently closing during use of stage 820. Examples of polymer materials from which each post 828 may be formed include, but are not limited to, photo resist, PDMS, or a flexible material selected from the group, which includes both dielectric and non-dielectric materials, consisting of a highly cross-linked uv-curable or thermal-curable polymer, a highly cross-linked uv-curable or thermal-curable plastic, a polysiloxane compound, silicon, silicon dioxide, spin-on glass, and a solgel material. In other implementations, each of post 828 may form from other materials.

Head portion 830 of each of pillars 826 serves as the active portion of each of pillars 824. Head portions 828 of each of pillars 826A, 826B, 8260 and 826D reside on top of their respective pillars 826 and are movable into proximity with the head portion 828 of at least one additional pillar 826. Head portion 830 of pillars 826A are similar to stage 20 described above. Each of head portions 828 of pillars 826 comprises plasmonically active layer 40 and transition metal photocatalytic layer 46 described above.

In the example illustrated, transition metal photocatalytic layer 46 of pillars 826A are irradiated which results in layer 46 causing photocatalytic oxidation of nearby molecules, producing free radicals they clean plasmonically active surface 42 of layer 40. The subsequently applied analyte may adsorb to layer 46 and side surfaces 42 of layer 40. In such implementations, the thicknesses of layers 40 and 46 is sufficiently thin such that the subsequently applied analyte adsorbed to the upper surface of layer 46 is sufficiently close to the electric field between the layers 40 of at least two bent consecutive, adjacent pillars 826A to achieve enhanced optical response to an interrogating laser.

In some implementations, layer 46 may be incomplete, similar to layer 446 described above with respect to FIG. 5, wherein the subsequently applied analyte may adsorb to those portions of layer 40 facing upwards, away from substrate 822. For example, as shown by broken lines, in some implementations, pillars 826A may comprise an alternative layer 446′ centered or otherwise inset from the sides of pillars 826A, wherein the subsequently applied analyte may adsorb to the upper plasmonically active surface of layer 40 along the circumferential perimeter of pillars 826A. In such implementations, the adsorbed analyte is closer to layer 40, achieving more enhanced optical response to an interrogating laser.

Head portion 830 of each of pillars 826B is similar to stage 220 described above. Each head portion 830 of pillars 826B comprises plasmonically active layer 40, transition metal photocatalytic layer 46 and adhesive layer 248, each of which is described above. The use of pillars 826B to interrogate an analyte is described below with respect to FIG. 13-17.

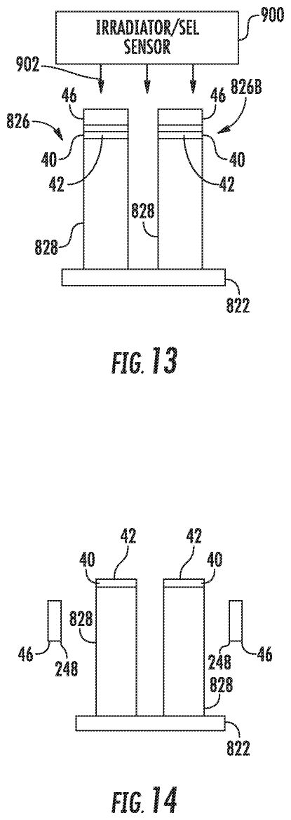

As shown by FIG. 13, an irradiator 900 irradiates pillars 826B with light, such as ultraviolet light 902. Light 902 causes photocatalytic layer 46 to undergo photocatalytic oxidation, producing free radicals that remove or clean contaminants from surface 42 of layer 40. The same light 829 breaks down adhesive layer 248 or degrades adhesive layer 248. As a result, as shown in FIG. 14, the adhesive layer 248 and the photocatalytic layer 46 separate and fall from surfaces 42 of plasmonically active layer 40, leaving clean and exposed upper surfaces 42 of plasmonically active layer 40.

As shown by FIG. 15, the cleaned plasmonically active surface 42 is exposed to an analyte 904. The analyte 904 may be carried in a solution or gas/air borne. During such time, the analyte 904 may be adsorbed by the plasmonically active surface 42.

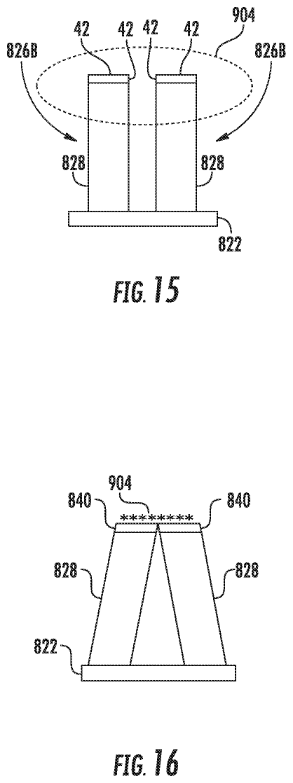

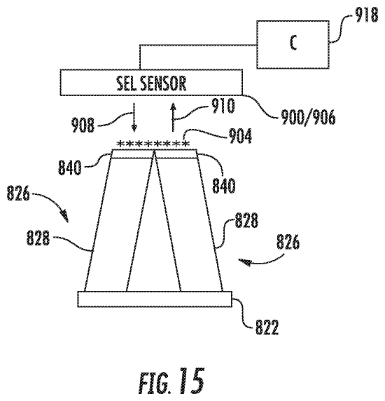

As shown by FIG. 16, pillars 826 are bent towards one another to move surfaces 42 of pillars 826B into close proximity with one another. In one implementation, surfaces 42 of pillars 8266 are moved to within 3 nm, nominally within 1 nm of one another, binding an analyte 904 therebetween. In one implementation, the analyte 904 is applied as a solution or liquid, wherein evaporation of the liquid results in pillars 826B closing together in response to capillary forces.

As shown by FIG. 17, a surface enhanced luminescence sensor, either the same irradiator 900 as was used to react the photocatalytic layer 46 in FIG. 13 or a different SEL sensor 906 irradiates the closed pillars 826B with light 908. The sensor 900/906 further detects light 910 emanating from the analyte 904 on the closed pillars 826B. For example, the sensor 900/906 may sense scattering of light or the fluorescence of the light emanating from analyte 904 in response to being impinged by light 908. The characteristics of the light 910 may be analyzed by a controller 918 to identify characteristics of analyte 904.

Once again referring to FIGS. 11 and 12, pillars 826C have head portions 830 which are similar to head portions 830 pillars 826A except pillars 826C comprise a transition metal photocatalytic layer 846 that extend along the sides of posts 828 rather than over the top of plasmonically active layer 40. Layer 846 is sufficiently close to plasmonically active layer 840 such that upon being irradiated during a cleaning phase, layer 846 causes photocatalytic oxidation, releasing free radicals sufficiently close to photocatalytic layer 40 so as to clean contaminants from surfaces 42 of each of layers 40. Thereafter, the cleaned photocatalytic layers 40 may be utilized to interrogate an analyte in a fashion similar to that described below with respect to FIGS. 15-17.

Although the present disclosure has been described with reference to example implementations, workers skilled in the art will recognize that changes may be made in form and detail without departing from the spirit and scope of the claimed subject matter. For example, although different example implementations may have been described as including one or more features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure,

What is claimed is:

1. A plasmonic analyte interrogation stage comprising:
a plasmonically active surface; and
a transition metal photocatalytic layer on the plasmonically active surface.

2. The plasmonic analyte interrogation stage of claim 1 further comprising an adhesive between the plasmonically active surface and the photocatalytic layer.

3. The plasmonic analyte interrogation stage of claim 1, wherein the photocatalytic layer comprises openings through which the plasmonically active surface is exposed.

4. The plasmonic analyte interrogation stage of claim 1, wherein the photocatalytic layer has a thickness of no greater than 10 nm.

5. The plasmonic analyte interrogation stage of claim 1, wherein the photocatalytic layer has a thickness of no greater than 2 nm.

6. The plasmonic analyte interrogation stage of claim 5, wherein the photocatalytic layer is imperforate.

7. The plasmonic analyte interrogation stage of claim 1 further comprising:
posts, wherein the posts are dimensioned to bend towards one another in response to capillary forces;
metallic caps on the posts, each of the metallic caps forming the plasmonically active surface.

8. The plasmonic analyte interrogation stage of claim 1 further comprising a porous layer of gold on the photocatalytic layer.

9. A surface enhanced luminescence (SEL) sensing stage comprising:
a substrate;
pillars rising from the substrate; each pillar comprising:
a rod formed from a non-photocatalytic material;
a plasmonically active cap supported by the rod; and
a transition metal photocatalytic layer proximate the plasmonically active cap.

10. The SEL sensing stage of claim 9, wherein the transition metal photocatalytic layer is on the plasmonically active cap.

11. The SEL sensing stage of claim 9, wherein the transition metal photocatalytic layer is on the rod, adjacent the plasmonically active cap.

12. The SEL sensing stage of claim 9, wherein the transition metal photocatalytic layer has a thickness of no greater than 2 nm.

13. The SEL sensing stage of claim 9, wherein the transition metal photocatalytic layer is an atomic layer deposition formed layer.

14. The SEL sensing stage of claim 9 further comprising an adhesive layer sandwiched between the plasmonically active surface and the transition a metal photocatalytic layer.

15. A method comprising:
irradiating a transition metal photocatalytic layer upon an analyte free plasmonically active surface to clean contaminants from the analyte free plasmonically active surface;
binding an analyte on or approximate to the cleaned plasmonically active surface; and
irradiating the analyte and the plasmonically active surface to interrogate the analyte.
